(19) United States
(12) Patent Application Publication
(10) Pub. No.: US 2010/0160890 A1
(43) Pub. Date: Jun. 24, 2010

(54) Syringe guide

(76) Inventor: Kenneth McOwen, Whittier, CA (US)

Correspondence Address: RUTH EURE, 4795 EDISON AVENUE, BOULDER, CO, 80301, US

(21) Appl. No.: 12/655,061

(22) Filed: Dec. 22, 2009

Related U.S. Application Data
(60) Provisional application No. 61/203,498, filed on Dec. 22, 2008.

(51) Int. Cl. A61J 1/20

(52) U.S. Cl. 604/415

(57) ABSTRACT

The Syringe Guide is an assistive device that is specially designed to couple a syringe and insulin bottle, providing a handy guide for needle insertion and extraction. Fabricated of a durable plastic material, this product is basically rectangular in shape, measuring approximately 6″ in length and 1.25″ in width and 1.5″ in depth. The length of the unit is expandable and is an open ended cylindrical receptacle, sized appropriately to completely house a standard insulin vial on one end, while the opposite end features a grooved trough, inside of which the user inserts the actual syringe.

### CLAIM OF PRIORITY

This patent application claims priority under 35 USC 119(e) (1) from U.S. Provisional Patent Application Ser. No. 61/203,498 filed Dec. 22, 2008, of common inventorship herewith entitled, “Syringe Guide.”

### FIELD OF THE INVENTION

The present invention pertains to the field of use of syringes in the field of medicine and more particularly to the field of syringe guides. Among these are:

U.S. Pat. No. 5,240,047 to Hedges describes a syringe guide and bottle holder which comprises a ring and trough for receiving a syringe for the purpose of loading a syringe from a bottle.

U.S. Pat. No. 5,247,972 to Tetreault also describes an alignment guide comprising a tube for hypodermic syringes for facilitating the withdrawal of fluid from one or more bottles.

U.S. Pat. No. 5,894,870 to Maxwell describes a syringe guide and vial holder comprising an open trough for filling a syringe from a vial.

None of these references exactly describe the present invention.

### SUMMARY OF THE INVENTION

It is an object of the present invention to provide a syringe guide for filling a syringe from a vial comprising an open trough, adjustable in length, having a flexible transparent canopy for accurate measurement.

### BRIEF DESCRIPTION OF THE DRAWINGS

FIG. 1 is a perspective view of the present invention.

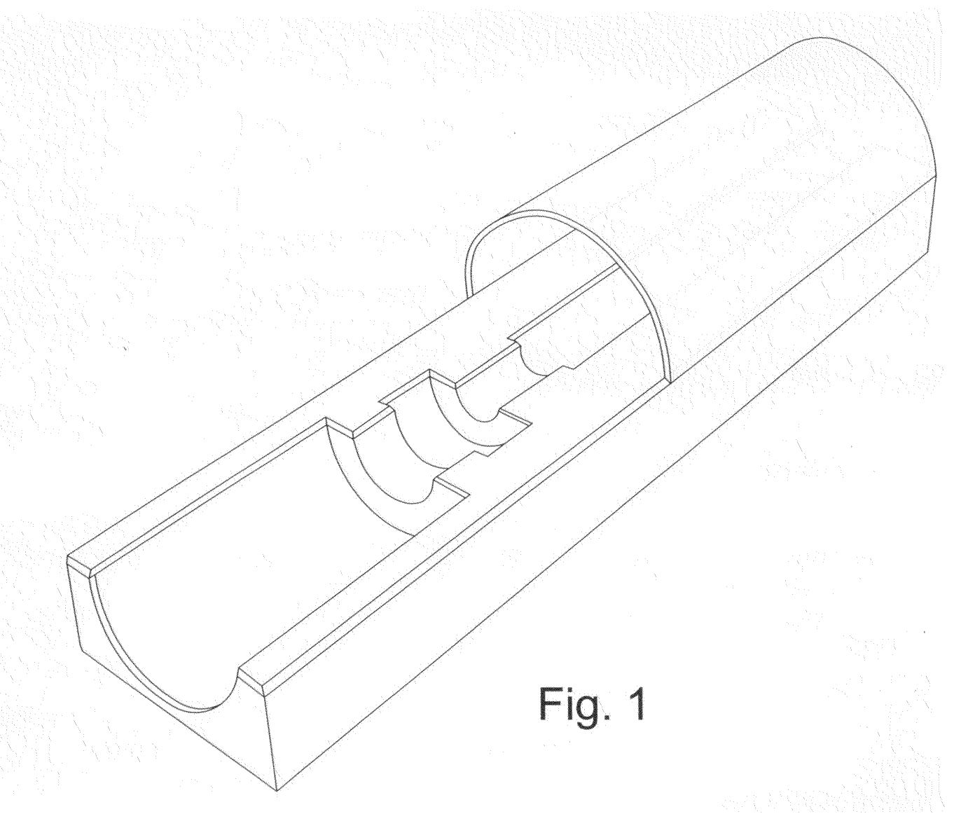

### DETAILED DESCRIPTION OF THE INVENTION

In administering insulin, most diabetics have to employ a needle, or syringe, to extract a solution from a small, temperature controlled glass vial. During this process, the patient inserts the needle into a rubber ingress point on the vial, then uses the plunger of the syringe to extract the prescribed amount on medication. While this process sounds relatively simple, many diabetics can encounter challenges when using a syringe and insulin vial.

Particularly, those with weak eyesight due to their condition can find it quite difficult to accurately insert a needle into such a small area as the top of the insulin vial. As a result of missing the mark, these users tend to break the needle, ruining a costly syringe. Additionally, patients with limited hand mobility face a daunting task when trying to manage the syringe and vial, as their condition may make it almost impossible to fill a syringe on their own.

The present invention, hereinafter referred to as the Syringe Guide, offers a convenient solution to the aforementioned problems.

As the name implies, the Syringe Guide is just that, an assistive device that is specially designed to couple a syringe and insulin bottle, providing a handy guide for needle insertion and extraction. Fabricated of a durable plastic material, this product is basically rectangular in shape, measuring approximately 6″ in length and 1.25″ in width and 1.5″ in depth. The length of the unit is expandable and is an open ended cylindrical receptacle, sized appropriately to completely house a standard insulin vial on one end, while the opposite end features a grooved trough, inside of which the user inserts the actual syringe.

This trough serves as a channel for a syringe, guiding a needle into the unit so that it slides unencumbered to meet the insulin vial at the bottom. Notably, the top of the comprises a clear, magnifying “glass” canopy of the same shatterproof plastic as the base and designed to enable the user to easily determine the proper dosage of medication. As an additional consideration, this product can be offered with a handy carrying case to facilitate storage and portability when not in use.

Use and application of the Syringe Guide is very simple and straightforward. Taking an insulin vial from the refrigerator or other cool storage area, the user would places the top of the bottle into the bottom of the Syringe Guide, inserting the vial into the receptacle until it fits completely into place.

Next, a syringe, with needle end first, is inserted into the top channel of the Syringe Guide. Pushing the syringe downward, the user is able to depend on the walls of the channel to lead the needle directly into its intended target, the rubber top of the insulin bottle. The user then retracts the plunger to fill the syringe with the proper insulin dosage, and by simply pulling the whole syringe from the Syringe Guide's channel, the syringe is filled and ready for use.

There are several significant benefits and advantages associated with this clever product invention. Foremost, the Syringe Guide provides diabetics with a more user-friendly means of taking their needed medication. A convenient assistive device that joins a syringe and insulin vial, this clever product alleviates the many hassles that can be encountered when on an insulin regimen. Eliminating the need to manually insert a needle into the top of an insulin vial, the Syringe Guide provides a more simplified approach, via its handy channel system and integrated magnifying canopy. In this manner, diabetics who have poor eyesight need not struggle to mate a needle with the insulin bottle's small ingress point, ending the risk that a needle will break or cause insulin spillage.

Additionally, those impacted by hand tremors or similar ailments find the Syringe Guide an invaluable tool, allowing them to prepare their medication in a matter of seconds, without assistance. Compact, lightweight, and equipped with its own case, the Syringe Guide can be comfortably carried anywhere, whether to work, to school, or to a beach or shopping excursion. Ideal for everyday use, this versatile product also proves invaluable while traveling. Offered in a vast array of attractive colors, there is sure to be a system to appeal to virtually any user. Made of durable, high-quality materials, the Syringe Guide will withstand years of continued use. The Syringe Guide is an innovative invention that effectively fosters peace of mind in diabetics who depend on insulin for their well-being and survival.

Extremely easy to use, this product offers instant accessibility to insulin whenever an injection is needed.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A syringe guide, to couple a syringe and insulin bottle, providing a handy guide for needle insertion and extraction comprising durable plastic material, basically rectangular in shape, having a first end and a second end, measuring approximately 6″ in length and 1.25″ in width and 1.5″ in depth wherein the length of the unit is expandable and is an open ended cylindrical receptacle, sized appropriately to completely house a standard insulin vial at its first end, and a grooved trough, inside of which the user inserts the actual syringe, at its second end.

2. The syringe guide of claim 1 further comprising a clear plastic magnifying canopy of shatterproof plastic to enable the user to easily determine the proper dosage of medication.

3. The syringe guide of claim 1, further comprising a handy carrying case to facilitate storage and portability when not in use.

4. The syringe guide of claim 2, further comprising a handy carrying case to facilitate storage and portability when not in use.
